(19) United States
(12) Patent Application Publication
(10) Pub. No.: US 2012/0070549 A1
(43) Pub. Date: Mar. 22, 2012

(54) METHOD OF TREATING A FOOD PRODUCT WITH AN ANTIMICROBIAL AGENT COMPOSITION AND A TREATED FOOD PRODUCT

(75) Inventors: Timothy A. Gutzmann, Eagan, MN (US); John D. Hilgren, Shoreview, MN (US)

(73) Assignee: ECOLAB USA INC., ST. PAUL, MN (US)

(21) Appl. No.: 12/887,073

(22) Filed: Sep. 21, 2010

(51) Int. Cl. A23L 3/34

(52) U.S. Cl. 426/281; 426/532

(57) ABSTRACT

A method of treating a food product with an antimicrobial agent composition is described. The method includes steps of applying an antimicrobial agent composition to a food product, subjecting the food product to a negative pressure environment wherein the negative pressure environment comprises a pressure that is at least 10 mm Hg below atmospheric pressure, and releasing the negative pressure environment to atmospheric pressure at a rate sufficient to cause a reduction in the amount of microbes as compared to applying an antimicrobial agent without the application of negative pressure. The method of the invention may cause infusion of at least a portion of the antimicrobial agent composition into the food product. A food product treated with an antimicrobial agent composition is described.

### FIELD OF THE INVENTION

The invention is directed to a method of treating a food product with an antimicrobial agent composition and to a treated food product.

### BACKGROUND OF THE INVENTION

The preservation of food products is a primary concern in the food industry. Food-product preservation is important for a variety of reasons, including providing palatable and nutritional products, protecting people and animals from food-born diseases, and improving the storage time for foods. Food-product preservation generally relies on reducing the number of contaminants such as the number of bacteria, yeasts, molds, viruses, and parasites.

Many food-processing techniques suitable for preserving food products have been developed. One technique suitable for preserving food products includes high-pressure treatment of food products. One high-pressure treatment of food products involves applying pressures of at least 200 MPa to a food product, such as some fruits and vegetables, for at least 5 days. But pressurizing food products for at least 5 days is not economically feasible and much shorter times for processing are preferred. Another high-pressure treatment that involves applying pressures of at least 2,000 atm requires about 5 to 120 minutes but is used for natural fruit juices. High-pressure treatments are difficult to use with food products such as fruits and vegetables because it can cause physical changes in the food product by, for example, breaking up cellular structure. Also, some microorganisms can be resistant to high-pressure treatments, making high-pressure treatments unsuitable for preserving some types of food products.

Other food-processing techniques include treating a food with antimicrobial agents that are suitable for reducing the number of microorganisms. Such treatments can include spraying a food product with a chemical agent, submerging or soaking a food in a chemical agent, and washing a food with a chemical agent. Such methods are particularly useful against the growth of microorganisms on the surface of food products. But a food product can also contain microorganisms below its surface where the food product may not be desirably affected by surface treatment with an antimicrobial agent.

### SUMMARY OF THE INVENTION

A method of treating a food product with an antimicrobial agent composition is provided according to the invention. The method includes steps of applying an antimicrobial agent composition to a food product to provide a treated food product, subjecting the food product to a negative pressure environment wherein the negative pressure environment comprises a pressure that is at least 10 mm Hg below atmospheric pressure, and releasing the negative pressure environment to atmospheric pressure at a rate sufficient to preserve the food product.

A method of infusing a food product with an antimicrobial agent composition is provided according to the invention. The method includes steps of applying an antimicrobial agent composition to a food product to provide a treated food product, subjecting the food product to a negative pressure environment wherein the negative pressure environment comprises a pressure that is at least 10 mm Hg below atmospheric pressure, and releasing the negative pressure environment to atmospheric pressure at a rate sufficient to cause infusion of at least a portion of the antimicrobial agent into the food product. The method further includes providing the antimicrobial agent composition at a weight ratio of antimicrobial agent to food product of between about 0.1:10 and about 10:0.1

A food product treated with an antimicrobial agent composition is provided according to the invention. The food product treated with an antimicrobial agent composition can be the result of the above method.

A food product infused with an antimicrobial agent is provided according to the invention. The product infused with an antimicrobial agent composition can be the result of the above method of infusing a food product with a antimicrobial agent composition.

### BRIEF DESCRIPTION OF THE FIGURES

FIG. 1A shows the number of microbial contaminants identified in sliced onions that were exposed to water or peracid and treated with a range of negative pressures and 0 pressure.

FIG. 1B shows the number of microbial contaminants identified in sliced onions that were exposed to water or peracid and treated with a range of positive pressures and 0 pressure.

FIG. 1C shows the number of microbial contaminants identified in chopped onions that were exposed to water or chlorine dioxide and treated with a range of positive pressures and 0 pressure.

FIG. 2 shows the number of microbial contaminants identified in chopped lettuce that was exposed to water, peracid, chlorine, or chlorine dioxide and treated with 0 pressure, 28 inches Hg, or 100 psi.

### DETAILED DESCRIPTION

In some aspects the present invention provides methods for preserving a food product. In other aspects the invention relates to a method of treating a food product with an antimicrobial agent composition. In yet other aspects, the invention provides a method of infusing an antimicrobial agent composition into a food product. In all aspects it is expected that the food product will experience food preservation. That is, the food product will last longer without spoilage compared with non-treated food product. It should be understood that the method of the invention can be characterized as a method of preserving a food product. It should be understood that the preservation of the food product is particularly directed at microorganisms that can cause spoilage of food products.

The term “food product” as used herein includes any food or food material, either alone or in combination with another substance, that provides a nutritional or flavor value, which is suitable for consumption by humans or animals. Food products that can be treated according to the invention may have subsurface contaminants or may be susceptible to subsurface contaminants. A concern exists that certain techniques for applying an antimicrobial agent composition to food products do not adequately address the possible existence of subsurface contamination. Subsurface contamination refers to the existence of contaminants below the surface of the food product. Exemplary food products that may include subsurface contamination include fruits, vegetables, meats, dairy products, and grains.

Exemplary fruits that can be treated according to the invention include, for example, tropical fruits such as pineapples, mangos, papayas, bananas, etc.; berries such as blueberries, strawberries, raspberries, etc.; citrus fruits such as oranges, lemons, limes, grapefruits, etc.; melons such as cantaloupes, honeydew melons, watermelons, etc.; and other fruits such as apples, pears, grapes, cherries, peaches, nectarines, tomatoes, etc. Fruits can be whole; separated into sections (i.e., separated along natural divisions in the fruit) such as, for example, orange or grapefruit sections; unpeeled (i.e., the fruit still has its rind, peel, or skin) such as, for example, unpeeled oranges, unpeeled lemons, unpeeled grapefruits, unpeeled pineapples, unpeeled apples, unpeeled kiwis, unpeeled bananas, etc.; peeled (i.e., the rind, peel, or skin of the fruit has been removed) such as peeled tangerines, peeled oranges, peeled apples, peeled pineapples, etc.; cut into pieces; chopped; etc.

Exemplary vegetables that can be treated according to the invention include, for example, root vegetables such as celery, leeks, carrots, onions, garlic, beets, potatoes, etc.; leafy greens such as Swiss chard, romaine, cabbage, broccoli rabbet, beet greens, spinach, etc.; greens such as broccoli, asparagus, green beans, Brussels sprouts, etc.; squash such as zucchini squash, yellow squash, spaghetti squash, acorn squash, pumpkins, etc.; and other vegetables such as corn, peppers, jalapenos, etc. Vegetables can be whole; cut into pieces; chopped; separated into sections (i.e., separated along natural divisions in the vegetable) such as garlic cloves, onion shells, corn kernels, etc.; separated from bunches into leaves such as spinach leaves, romaine leaves, Swiss chard leaves, etc.; unpeeled (i.e., the vegetable still has its rind, skin, or peel) such as unpeeled carrots, unpeeled onions, unpeeled garlic, unpeeled potatoes, unpeeled zucchini squash, unpeeled acorn squash, unhusked corn, etc.; and peeled (i.e., the rind, skin, or peel of the vegetable has been removed) such as peeled carrots, peeled onions, peeled garlic, peeled potatoes, peeled zucchini squash, peeled acorn squash, husked corn, etc.

Exemplary meats that can be treated according to the invention include beef; poultry such as turkey, chicken, duck, etc.; pork; fish such as salmon, shark, sea bass, tuna, grouper, orange roughly, red snapper, trout, etc.; shellfish such as shrimp, crawfish, lobster, crab, etc.; and game such as elk, venison, rabbit, etc. Meats can be whole such as, for example, a whole animal carcass; portions of an animal such as, for example, beef steaks, beef roast, pork loin, pork roast, bacon, ham, poultry pieces, etc.; unskinned (i.e., the meat still has its skin) such as unskinned chicken, unskinned turkey, unskinned salmon, unskinned trout, etc.; skinned (i.e., the skin of the meat has been removed) such as skinless chicken, skinless turkey, skinless salmon, skinless trout, etc.; or processed such as, for example, sausage, hot dogs, bologna, pepperoni, etc.

Exemplary dairy products that can be treated according to the invention include butter; ice cream; eggs; and cheese such as mozzarella cheese, cheddar cheese, jack cheese, etc.; among others. Exemplary grains that can be treated according to the invention include barley, wheat, rye, sorghum, corn, and oats, among others.

The invention can also be used to preserve a variety of nonfood products that are, for example, porous or woven. Examples of suitable nonfood products include textiles such as cottons, wools, silks, synthetic fabrics (e.g., polyester, polyolefins, acrylics), etc.; wood and cellulose-based systems such as paper; and stones such as granites, slates, various aggregates, etc. Nonfood products that can be treated according to the invention can be generally characterized as natural, organic, or synthetic substances.

The antimicrobial agent includes composition having preservative activity. In general, antimicrobial activity refers to activity that provides or contributes to palatable and nutritional food products, activity that can protect or contribute to the protection of people and animals from contaminant-related illnesses, activity that can improve or contribute to improving the storage time of a treated substance, and/or activity that can maintain or assist in maintaining the structural activity of a treated substance. The term, “antimicrobial agent” as used herein can exhibit antibacterial activity, antifungal activity, antiviral activity, antiparasitic activity, etc. An antimicrobial agent composition can reduce the number of contaminants such as bacteria, yeasts, molds, parasites, worms, worm eggs, viruses, etc.

The antimicrobial agent composition can be chosen such that it does not adversely affect the substance undergoing the preservation method. The antimicrobial agent composition should not render the food product inedible and should be ingestible by humans or animals in at least limited quantities without high toxicity.

Exemplary antimicrobial agents exhibiting preservative activity that can be used according to the invention include aldehydes such as formaldehyde and glutaraldehyde; iodophors such as iodine-nonionic surfactant complexes, iodine-polyvinyl pyrrolidone complexes, iodine-quaternary ammonium chloride complexes, amphoteric iodine-amine oxide complexes, etc.; fatty acids such as decanoic acid, octanoic acid, etc.; anionic surfactants such as dodecylbenzene sulfonic acid, sodium 1-octane sulfonate, etc.; phenols such as o-phenylphenol, 2,4,5-trichlorophenol, and 2,3,4,6-tetrachlorophenol (commercially available from The Dow Chemical Company and Mobay Chemical Company); cationic surfactants such as quaternary ammonium chloride surfactants including N-alkyl(C₁₂₋₁₈)dimethylbenzyl ammonium chloride, N-alkyl(C₁₄₋₁₈)dimethylbenzyl ammonium chloride, N-tetradecyldimethylbenzyl ammonium chloride monohydrate, N-alkyl(C₁₂₋₁₄)dimethyl 1-naphthylmethyl ammonium chloride (commercially available from Stepan Chemical Company).

Other examples of chemical agents suitable for use according to the invention include halo-containing antimicrobial agents such as iodine, chlorine, chlorine dioxide, chlorine encapsulated in releasing agents such as alkali or alkaline earth metal hypochlorites (e.g., NaOCl, LiOCl, Ca(OCl)₂); C₁-C₁₈ peroxy acids, which are products of the oxidation of a C₁-C₁₈ fatty acid or of the oxidation of a mixture of C₁-C₁₈ fatty acids; hypochlorite such as alkali hypochlorites, alkaline earth metal hypochlorites, acidified sodium chlorite, ozone, organic acids, mineral acids, blends of organic and mineral acids, quaternary ammonium compounds, bacteriocins, etc.; C₂-C₁₈ organic acids, preferably C₈-C₁₀ organic acids; an ester derivative of a C₂-C₁₈ organic acid; and peracid, which is a mixture of acetic acid and hydrogen peroxide.

The antimicrobial agent composition should include the chemical agent in a concentration effective for reducing contaminant numbers. But the concentration should not exceed an amount that would substantially adversely affect the exposed substance. For example, the chemical agent should not be used in a concentration that would render the food product infused with the antimicrobial agent composition toxic for human or animal consumption.

The effective concentration will depend on a variety of factors such as, for example, the potency of the specific antimicrobial agent, the desired reduction in contaminant numbers, the type of substance, and the conditions under which the method is carried out including temperature, pressure, and length of time. Each of these factors will be discussed in turn.

The potency of a chemical agent can affect the effective concentration of the chemical agent. The potency refers to a chemical agent's ability to preserve a substance. And the potency varies depending on the chemical agent used. Thus, larger effective concentrations can be required of less potent chemical agents than of more potent antimicrobial agents if all other factors are equal. For example, chemical agents such as ozone and chlorine dioxide can be used in smaller concentrations than can quaternary ammonium compounds.

The desired amount of reduction in contaminant number can affect the effective concentration of the chemical agent. The desired amount of reduction in contaminant number can be based on industry standards, government regulations, and the like. A desirable contaminant reduction is typically about a 1 log reduction in measured contaminants. Preferably the contaminant reduction is a 2 log reduction, and more preferably the contaminant reduction is a 3 log reduction. Contaminant reduction can also be described according to percent reduction in contaminants. If percent reduction is used, a desirable contaminant reduction is typically about a 90% reduction, preferably a 99% reduction and more preferably a 99.9% reduction, in the number of measured contaminants. To achieve a 99.9% reduction in contaminant number, a higher effective concentration of chemical agent would be required than to achieve a 90% reduction in contaminant, all other factors being equal (e.g., the same type of antimicrobial agent, same length of time, same pressure, same temperature, etc.).

Methods for determining the contaminant reduction are known in the art. In general, contaminant reduction is a relative value that compares the number of contaminants in a substance prior to treatment with the number of contaminants in a substance after treatment. A reduction in contaminant number can be determined for any one or more of the contaminants of interest, for example, bacteria, yeasts, molds, viruses, etc. Typically a test will measure a particular type of contaminant such as, for example, bacteria because known tests are conducted under specific conditions and different contaminants require different conditions, for example, different media for propagation. One test is known as a total plate count. A total plate count can be used to measure all aerobic bacteria, but to measure Coliform, which is a specific class of bacteria, a specific Coliform test must be conducted. Similarly, to measure yeasts and molds, a test specific for yeasts and molds must be conducted. These tests are well known in the art.

The type of substance treated can also affect the effective concentration of the antimicrobial agent because, for example, substances vary in their levels of contaminants and in their physical and chemical characteristics. For example, an onion, may contain more contaminants, and have a higher level of reducing agents, than a second food product, such as, for example, an orange. If all other conditions of an antimicrobial process using an oxidizing biocide are the same (e.g., same type of antimicrobial agent, same temperature, same pressure, same length of time, etc.), than a higher concentration of an antimicrobial agent would be needed to achieve the same reduction in contaminant number

The conditions under which the method is carried out (i.e., operating conditions) can further affect the effective concentration of the antimicrobial agent. Examples of conditions include temperature, time of treatment, or pressure. Any particular method can be carried out with a particular concentration of antimicrobial agent (C₁) at a particular temperature (T₁) for a particular amount of time (t₁) and under a particular pressure (P₁). When each of these parameters is fixed and a desirable reduction in contaminant number is achieved, for example, a 1 log reduction, then this method, for purposes of illustration, can be called a standard method. If any one of temperature, pressure, or time is altered from those in the standard method in such a way as to promote preservation and the others remain constant, then the concentration of the antimicrobial agent can be proportionately reduced and the method of the invention can be useful to achieve substantially the same reduction in contaminant number. The term “proportionately” as used herein includes being altered to compensate for the effect caused by the changed parameter or being altered to restore the symmetry that was altered by the changed parameter.

To promote preservation, the parameters can be altered in the following ways. For example, temperature can be increased, time of treatment can be increased, negative pressure can be made more negative (i.e., the negative pressure can be brought at least incrementally closer to a 0 pressure), or the rate of pressure release can be increased or decreased relative to the parameters in the standard method.

Alternatively, if any one of temperature, pressure, time, or rate is altered from the standard method in such a way as to adversely affect preservation and the others remain constant, then the concentration of the antimicrobial agent can be proportionately increased and the method of the invention can be useful to achieve about the same reduction in contaminant number.

To adversely affect preservation, the parameters can be altered in the following ways. For example, temperature can be decreased, time of treatment can be decreased, negative pressure can be made less negative, or the rate of pressure release can be increased relative to the parameters in the standard method.

A summary of exemplary preservative agents, effects, and concentrations may be found in Table 1.

TABLE 1
Efficacy and Concentration of Exemplary Antimicrobial Agent

| Antimicrobial | | |
|---|---|---|
| Agent | | Exemplary |
| Category | Exemplary Antimicrobial agent | Concentration |
| Halogens | Chlorine, acidified sodium chlorite, | 1 to 10,000 ppm |
| | sodium/calcium hypochlorite, | |
| | iodophors | |
| Peroxygen | Peroxyacetic acid, hydrogen | 1 to 10,000 ppm |
| compounds | peroxide | |
| Other | Chlorine dioxide, ozone, carbon | 0.1 to 1,000 ppm |
| | dioxide | |
| Surface-active | Cetylpyridinium chloride | 1 to 10,000 ppm |
| agents | | |
| Organic acids | Lactic acid, citric acid, medium- | 5 to 50,000 ppm |
| | chain fatty acids | |
| Fatty Acids | C₆-C₁₈ fatty acids; Octanoic acid, | |
| | Decanoic acid | |
| Mineral acids | Hydrochloric acid, phosphoric | 5 to 50,000 ppm |
| | acid, sulfuric acid | |
| Naturally- | Phenolic compounds from spices, | 5 to 50,000 ppm |
| occurring | essential oils from spices, | |
| compounds | lactoferrin | |
| Bacteriocins | Nisin, pediocin, brevicin | 1 ppb to 10,000 ppb |

The antimicrobial agent composition can include the chemical agent alone or in combination with other additives or ingredients. For example, it may be desirable to include an additive or additives that help solubilize the chemical agent, affect foam formation, control hard water, stabilize the composition, further enhance the preservative activity of the composition, and the like. Exemplary additives include carriers, adjuvants, pH modifiers, surfactants, stabilizers, water conditioners, etc.

Suitable carriers can, for example, facilitate the transport of the chemical agent to the surface of the food product. In some instances, a carrier can also facilitate the maintenance of the chemical agent on the surface of the food product. Examples of carriers are known in the art and include water; alkyl alcohols such as ethanol, isopropanol, n-propanol, etc.; polyols such as propylene glycol, polyethylene glycol, glycerol, sorbitol, etc.; vegetable oils such as canola, soybean, corn vegetable oil, etc; alkane hydrocarbons such as mineral oil, liquid paraffins, iso-paraffins, paraffin waxes etc; waxes such as carnauba, bees, etc; and the like.

Suitable adjuvants can, for example, maintain the storage stability of the composition containing the chemical agent, facilitate solubilization of the chemical agent, and the like. Exemplary adjuvants include coupling agents, solubilizers, and hydrotropes. Exemplary coupling agents include linear alkyl alcohols such as ethanol, isopropanol, etc.; polyfunctional organic alcohols such as glycerol, polyethylene glycol, propylene glycol, sorbitol, and the like. Exemplary solubilizers include surfactants as described below, propylene glycol esters, glycerol esters, polyoxyethylene glycerol esters, polyglycerol esters, sorbitan esters, polyoxyethylene sorbitan esters, polyoxyethylene-polyoxypropylene polymers, sulfonates, dioctyl sodium succinate, stearoyl lactylate, and complex esters such as acetylated, lactylated, citrated, succinylated, diacetyl triturated glycerides, alkyl glucosides, mannosides and galactosides to name a few. Exemplary hydrotropes include xylene-, cumene-, toluene sulfonic acids, alkyl benzene sulfonic acids, n-octane sulfonic acids, naphthalenesulfonic acids, alkyl- and dialkyl naphthalenesulfonic acids, diphenyletherdisulfonic acids, or their alkali metal salts to name a few.

Suitable pH modifiers include acidulants and alkaline agents. Acidulants can reduce the pH of the antimicrobial agent composition, and alkaline agents can raise the pH of the antimicrobial agent composition. Exemplary acidulants include lactic acid, phosphoric acid, sulfuric acid, adipic acid, tartaric acid, succinic acid, acetic acid, propionic acid, citric acid, malic acid, or mixtures thereof. Exemplary alkaline agents include amines; alkali metal hydroxides such as sodium hydroxide and potassium hydroxide; carbonates such as sodium carbonate, potassium carbonate, sodium or potassium bicarbonate, and sesquicarbonate; phosphates such as cyclic phosphates (e.g., sodium or potassium orthophosphate) and alkaline-condensed phosphates (e.g., sodium or potassium pyrophosphate, sodium tripolyphosphate, and sodium hexametaphosphate); and silicates such as alkali metal ortho-, meta-, di-, tri-, and tetrasilicate (e.g., sodium orthosilicate, sodium sesquisilicate, sodium esquisilicate pentahydrate, sodium metasilicate, sodium metasilicate pentahydrate, sodium metasilicate hexahydrate, potassium metasilicate, potassium metasilicate hemihydrate, potassium silicate monohydrate, potassium disilicate, etc.).

Exemplary surfactants include nonionic surfactants, zwitterionic surfactants, amphoteric surfactants, cationic surfactants, and anionic surfactants. Exemplary nonionic surfactants include nonylphenol ethoxylates, linear alkyl alcohol ethoxylates, ethylene oxide/propylene oxide block copolymers (e.g., Pluronic™ surfactants commercially available from BASF Wyandotte), alkanolamides, ethoxylated alkanolamides, ethylene bisamides, etc. Exemplary anionic surfactants include alkali metal or ammonium salts of, for example, aryl sulfonates, alkyl sulfonates, alkylaryl sulfonates, alkylether sulfonates, olefin sulfonates, alkyl sulfates, alkylether sulfates, phosphate esters, etc. Exemplary amphoteric or zwitterionic surfactants include N-coco-3-aminopropionic acid and acid salts, N-tallow-3-iminodipropionate salts, N-lauryl-3-iminodipropionate disodium salt, N-carboxymethyl-N-cocoalkyl-N-dimethylammonium hydroxide, N-carboxymethyl-N-dimethyl-N-(9-octadecenyl)ammonium hydroxide, (1-carboxyheptadecyl)trimethylammonium hydroxide, (1-carboxyundecyl)trimethylammonium hydroxide, etc. Exemplary cationic surfactants include quaternary ammonium compounds.

Exemplary stabilizers include chelating agents as described below and surfactants as already described.

Exemplary water conditioners include chelating agents and other compounds that prevent or reduce the likelihood of cations and anions precipitating out of solution. Exemplary water conditioners include, for example, polymers of polyacrylic acid, such as polyacrylic acid, polymethacrylic acid, acrylic acid-methacrylic acid copolymers, hydrolyzed polyacrylamide, hydrolyzed polymethacrylamide, hydrolyzed acrylamide-methacrylamide copolymers, hydrolyzed polyacrylamide; phosphonic acids, such as, aminotri(methylenephosphonic acid), 1-hydroxyethylidene-1,1-diphosphonic acid, hexamethylenediaminetetra(methylenephosphonic acid), diethylenetriaminepenta(methylenephosphonic acid), phosphonobutane tricarboxylic acid; and chelators, such as ethylenediaminetetraacetic acid (EDTA), hydroxyethyl ethylenediaminetriacetic acid (HEDTA), diethylenetriaminepentaacetic acid (DTPA) and nitrilotriacetic acid (NTA).

The type and amount of an additive or ingredient included in the antimicrobial agent composition can be chosen such that it does not adversely affect the activity of the chemical agent and does not substantially adversely affect the substance that is exposed. For example, the type and amount of an additive or ingredient included in a composition containing a chemical agent used in a method for preserving a food product should not render the food product being infused with the antimicrobial agent composition inedible.

The antimicrobial agent composition can be provided in any form suitable for treating a substance such as a food product. Examples of suitable forms include a neat solution, liquid concentrate, dispersion, emulsion, aerosol, gel, solid, etc. An exemplary form of the antimicrobial agent is a liquid whether the item to be treated is immersed in the antimicrobial agent or the antimicrobial agent is sprayed onto the surface.

The method of infusing a food product includes steps of treating a food product with the antimicrobial agent composition to provide a treated food product, subjecting the treated food product to a negative pressure environment wherein the negative pressure environment comprises a pressure that is at least 40 mm Hg below atmospheric pressure, and releasing the negative pressure environment to atmospheric pressure at a rate sufficient to cause infusion of at least a portion of the antimicrobial agent composition into the food product.

The antimicrobial agent composition can be provided in any form suitable for treating the food product. Exemplary forms include as a neat solution, liquid concentrate, dispersion, emulsion, aerosol, gel, solid, etc. The treatment should be sufficient to provide a coating of the antimicrobial agent composition on the exterior surface of the food product.

Examples of exposing a food product to an antimicrobial agent include contacting, submerging, immersing, spraying, washing, soaking, scrubbing, packaging a food product with an antimicrobial agent. The temperature at which the food product is exposed to an antimicrobial agent should be such that it does not adversely affect the food. Typically the food product can be exposed to an antimicrobial agent at temperatures between about 32 and about 140° F., between about 38 and about 110° F., between about 42 and 90° F., and between about 45 and 80° F. The skilled artisan will appreciate that the temperatures at which the food product is exposed to the antimicrobial agent are insufficient to alone kill any microbes. That is, the invention method does not rely upon thermal treatment to reduce microbial count.

The method of the present invention does not require an antimicrobial rinse. In fact, the method of the invention preferably excludes a post-treatment antimicrobial rinse. If any post-treatment rinse is conducted it desirably does not include an antimicrobial agent. One reason for this is taste. Since an object of the invention is to treat food and food products and to reduce the microbial load on such food and food products, it is undesirable that residue build up from the antimicrobial agent that might unduly affect the taste. It is desirable to minimize any residue of the antimicrobial agent, that is, any more than is required for the treatment under pressure and the strategic release of the pressure.

Without being bound by theory, it is believed that once the antimicrobial agent composition is provided on the surface of the food product, it is desirable to cause the antimicrobial agent composition to infuse into the food product so that the antimicrobial agent composition contacts tissue below the surface of the food product. It should be understood that infusion of the antimicrobial agent composition into the food product refers to the antimicrobial agent composition penetrating into, diffusing into, passing through the surface of, entering below the surface of, or permeating into the interior tissue of the food product. However, infusion of the antimicrobial agent below the surface of the food product may or may not occur. One skilled in the art will recognize the benefits of practicing the invention, that is a reduction in food-borne microbes and pathogens, regardless of whether or not the antimicrobial agent actually is infused below the surface of the food product.

Again, without being bound by theory, it is believed that in general, the antimicrobial agent composition may be induced to infuse into the food product by creating a change in pressure that may draw the antimicrobial agent composition into the food product. However, as stated previously, whether or not the antimicrobial agent is actually infused beneath the surface of the food product, the present invention has benefits in reducing microbes present on the food product. For example, the treated food product can be provided in an environment at a first pressure, and the pressure can be rapidly increased to a second pressure to cause the antimicrobial agent composition to infuse into the food product. It has been found convenient for the first pressure condition to be subatmospheric and for the second pressure condition to be atmospheric. In this manner, the treated food product can be provided at a negative pressure (with respect to atmospheric pressure) and the pressure environment can be released to atmospheric pressure at a rate that is sufficient to draw the antimicrobial agent composition into the food product or at a rate that is sufficient to cause preservation of the food product by reducing microbial counts. It is believed that the reduction in microbes occurs as a result of three factors, these being (1) the antimicrobial agent, (2) the subatmospheric or high pressure environment, and (3) the controlled release of the subatmospheric or high pressure environment.

In some embodiments, a substance is treated with a negative pressure. Negative pressure refers to any pressure less than ambient pressure, including 0 pressure, which is a vacuum. The substance is treated with negative pressure in an amount effective for an antimicrobial agent to infuse the substance. The effective amount of negative pressure can depend on a variety of factors such as, for example, the desirable reduction in measured contaminants, the type of substance, the conditions under which the method is carried out (e.g., the concentration and type of the antimicrobial agent, the temperature, and the length of time), and the like. Each of these factors will be discussed in turn.

The desirable amount of reduction in measured contaminants, which is as described above, can affect the effective amount of negative pressure. For example, all other conditions being equal (e.g., same type and concentration of antimicrobial agent, same temperature, same length of time, etc.), a 99% reduction in measured contaminants can require more negative pressure (i.e., at least incrementally closer to 0 pressure) than a 90% reduction in measured contaminants. Conversely, a 90% reduction in measured contaminants can require less negative pressure than a 99% reduction in measured contaminants.

The type of substance treated can affect the effective amount of negative pressure because, for example, substances can vary in their levels of contaminants and in their physical characteristics. For example, if one food product, such as, for example, an onion, has more contaminants than a second food product, such as, for example, an orange, all other conditions of the process being the same (e.g., same type and amount of antimicrobial agent, same temperature, same length of time, etc.), a more negative pressure can be used on the onion to achieve substantially the same reduction in contaminant number as for the orange.

The conditions under which the method is carried out can further affect the effective amount of negative pressure. Examples of conditions include temperature and time of treatment and also include type and concentration of antimicrobial agent. As already described in reference to effective concentration of an antimicrobial agent, any particular method can be carried out with a particular type and concentration of antimicrobial agent (C₁) at a particular temperature (T₁) for a particular amount of time (t₁) and under a particular pressure (P₁). Again for illustration purposes, this method will be referred to as the standard method. If any one of temperature, time, or antimicrobial agent is altered from those in the standard method in such a way as to promote preservation and the others remain constant, then the negative pressure can be proportionately made less negative to achieve about the same reduction in contaminant number. “Proportionately” is as already defined.

To promote preservation, the parameters can be altered in the following ways. For example, temperature can be increased, time of treatment can be increased, or the type and/or concentration of the antimicrobial agent can be altered to result in a more effective antimicrobial agent relative to the parameters in the standard method. Likewise, the treatment pressure can be increased or decreased and the rate of release of the treatment pressure may be increased or decreased.

For example, all other conditions of the process being the same (e.g., same temperature, same type of substance, same length of time, etc.), if a more potent antimicrobial agent, either from type, concentration, or a combination of type and concentration, is used relative to C₁ in the standard method, then a less negative pressure can be used in the altered method than in the standard method to achieve substantially the same reduction in contaminant number.

Alternatively, if any one of temperature, time, and antimicrobial agent is altered from the standard method in such a way as to adversely affect preservation and the others remain constant. Then the negative pressure can be made proportionately more negative so the method of the invention can be useful to achieve substantially the same reduction in contaminant number.

To adversely affect preservation, the parameters can be altered in the following ways. For example, temperature can be decreased, time of treatment can be decreased, or the type and/or concentration of the antimicrobial agent can be altered to result in a less effective antimicrobial agent relative to the parameters in the standard method.

For example, all other conditions of the process being the same (e.g., same type and concentration of antimicrobial agent, same type of substance, same length of time, etc.), if a lower temperature relative to T₁ in the standard method is used, then a more negative pressure can be used in the altered method than in the standard method to achieve substantially the same reduction in contaminant number.

Generally a negative pressure of between about 0 and about 720 mm Hg can be used. Preferably a negative pressure of between about 0 and about 520 mm Hg is used. More preferably a negative pressure of between about 0 and about 320 mm Hg is used.

For food products, such a negative pressure can be applied for between about 1 second and about 60 minutes, preferably between about 2 seconds and about 40 minutes, and more preferably between about 1 minute and about 10 minutes. The length of time is measured from the time when the pressure is reached (i.e., the time required to change the pressure from atmospheric to the method pressure is excluded in the amount of time required) until the pressure is removed (i.e., the time required to return to atmospheric pressure is excluded from the amount of time required). A negative pressure can be applied to the food product at temperatures between about 32 and about 140° F., preferably between about 35 and about 120° F., more preferably between about 38° F. and about 110° F.

The release of the positive pressure or negative pressure as the case may be is between about 1 second and about 60 minutes, preferably between about 2 seconds and about 30 minutes, and more preferably between about 1 minute and about 10 minutes. The length of release time is measured from the time when the pressure is first released until the pressure is completely removed (i.e., the time required to return to atmospheric pressure is the amount of release time). The release of pressure can be applied to the food product at temperatures between about 32 and about 140° F., preferably between about 35 and about 120° F., more preferably between about 38° F. and about 110° F.

General process parameters for a method of the invention in which a food product is treated with negative pressure are illustrated in Table 2.

TABLE 2
Process Parameters for a Food Product Treated with
Negative Pressure

| Condition | Useful | Preferred | More Preferred |
|---|---|---|---|
| Temperature | 32 to 140° F. | 35 to 120° F. | 38 to 110° F. |
| (° F.) | | | |
| Time (min/sec) | 1 sec to 60 min | 2 sec to 40 min | 1 min to 10 min |
| Pressure | 0 to 720 mm Hg | 0 to 520 mm Hg | 0 to 320 mm Hg |
| (mm Hg) | | | |
| Release time | 1 sec to 60 min | 2 sec to 30 min | 1 min to 10 min |

A substance can be treated with a negative pressure prior to, subsequent to, or simultaneously with exposing a substance to an antimicrobial agent. Preferably a substance is treated with a negative pressure and exposing a substance to an antimicrobial agent.

Although this invention is not limited to any single theory, in the case of food products, one theory suggests that an antimicrobial agent can infuse a food product by treating it with negative pressure because void spaces are created in the food product by the negative pressure, and the antimicrobial agent is pulled into the void spaces as the negative pressure is released. Such is the theory of controlling the release of the pressure.

In other embodiments, a substance is treated with a positive pressure. A positive pressure refers to any pressure greater than ambient pressure. The substance is treated with positive pressure in an amount effective for an antimicrobial agent to infuse the substance. The effective amount of positive pressure can depend on a variety of factors such as, for example, the desirable reduction in measured contaminants, the type of substance, the conditions under which the method is carried out (e.g., the concentration and type of the antimicrobial agent, the temperature, and length of time), and the like. Each of these factors will be discussed in turn.

The desirable amount of reduction in measured contaminants, which is as described above, can affect the effective amount of positive pressure. For example, all other conditions being equal (e.g., same type and concentration of antimicrobial agent, same temperature, same length of time, etc.), a 99% reduction in measured contaminants can require more positive pressure than a 90% reduction in measured contaminants. Conversely, a 90% reduction in measured contaminants can require less positive pressure than a 99% reduction in measured contaminants.

The type of substance treated can affect the effective amount of positive pressure because, for example, substances can vary in their levels of contaminants and in their physical characteristics. For example, if one food product, such as, for example, an onion, has more contaminants than a second food product, such as, for example, an orange, all other conditions of the process being the same (e.g., same type and amount of antimicrobial agent, same temperature, same length of time, etc.), a more positive pressure can be used on the onion to achieve substantially the same reduction in contaminant number as for the orange.

The conditions under which the method is carried out can further affect the effective amount of positive pressure. Examples of conditions include temperature and time of treatment and also include type and concentration of antimicrobial agent. As already described in reference to effective concentration of an antimicrobial agent, any particular method can be carried out with a particular type and concentration of antimicrobial agent (C₁) at a particular temperature (T₁) for a particular amount of time (t₁) under a particular pressure (P₁) and such pressure may be released for a particular amount of time (t₂). Again for illustration purposes, this method will be referred to as the standard method. If any one of temperature, time, or antimicrobial agent is altered from those in the standard method in such a way as to promote preservation and the others remain constant, then the positive pressure can be proportionately made less positive to achieve about the same reduction in contaminant number. “Proportionately” is as already defined.

To promote preservation, the parameters can be altered in the following ways. For example, temperature can be increased, time of treatment can be increased, or the type and/or concentration of the antimicrobial agent can be altered to result in a more effective antimicrobial agent relative to the parameters in the standard method. The time to release the pressure may be altered as well.

For example, all other conditions of the process being the same (e.g., same temperature, same type of substance, same length of time, etc.), if a more potent antimicrobial agent, either from type, concentration, or a combination of type and concentration, is used relative to C₁ in the standard method, then a less positive pressure can be used in the altered method than in the standard method to achieve substantially the same reduction in contaminant number.

Alternatively, if any one of temperature, time (t₁ or t₂), and antimicrobial agent is altered from the standard method in such a way as to adversely affect preservation and the others remain constant. Then the positive pressure can be made proportionately more positive so the method of the invention can be useful to achieve substantially the same reduction in contaminant number.

To adversely affect preservation, the parameters can be altered in the following ways. For example, temperature can be decreased, time of treatment can be decreased, or the type and/or concentration of the antimicrobial agent can be altered to result in a less effective antimicrobial agent relative to the parameters in the standard method.

For example, all other conditions of the process being the same (e.g., same type and concentration of antimicrobial agent, same type of substance, same length of time, etc.), if a lower temperature relative to T₁ in the standard method is used, then a more positive pressure can be used in the altered method than in the standard method to achieve substantially the same reduction in contaminant number.

Generally a positive pressure of between about 1,200 and about 10,000 mm Hg can be used. Preferably a positive pressure of between about 1,450 and about 8,000 mm Hg is used. More preferably a positive pressure of between about 2,000 and about 6,000 mm Hg is used.

For food products, such a positive pressure can be applied for between about 1 second and about 60 minutes, preferably between about 2 seconds and about 40 minutes, and more preferably between about 1 minute and about 10 minutes. The length of time is measured from the time when the pressure is reached (i.e., the time required to change the pressure from atmospheric to the method pressure is excluded in the amount of time required) until the pressure is removed (i.e., the time required to return to atmospheric pressure is excluded from the amount of time required). A positive pressure can be applied to the food product at temperatures between about 32 and about 140° F., preferably between about 35 and about 120° F., more preferably between about 38° F. and about 110° F.

General process parameters for a method of the invention in which a food product is treated with positive pressure are illustrated in Table 3.

TABLE 3
Process Parameters for a Food Product Treated with
Positive Pressure

| Condition | Useful | Preferred | More Preferred |
|---|---|---|---|
| Temperature | 32 to 140° F. | 35 to 120° F. | 38 to 110° F. |
| (° F.) | | | |
| Time (min/sec) | 1 sec to 60 min | 2 sec to 40 min | 1 min to 10 min |
| Pressure | 1,200 to | 1,450 to | 2,000 to |
| (mm Hg) | 10,000 mm Hg | 8,000 mm Hg | 6,000 mm Hg |
| Release time | 1 second to | 2 seconds to | 1 minute to |
| (min/sec) | 60 minutes | 30 minutes | 10 minutes |

A substance can be treated with a positive pressure prior to, subsequent to, or simultaneously with exposing a substance to an antimicrobial agent. Preferably a substance is treated with a positive pressure and exposing a substance to an antimicrobial agent.

Although this invention is not limited to any single theory, one theory suggests that an antimicrobial agent can infuse a food product by treating the food product with a positive pressure because the positive pressure physically forces the antimicrobial agent to enter the food product.

Methods of the invention can include a repetition of any step in the method. For example, in some embodiments, a food product is exposed to a second antimicrobial agent. The second antimicrobial agent can be the same as the first antimicrobial agent or different from the first antimicrobial agent. To expose the food product to a second antimicrobial agent, the food product can be exposed to a first antimicrobial agent, treated with a positive and/or negative pressure, and then exposed to a second antimicrobial agent subsequent to or simultaneously with treating with a positive and/or negative pressure.

Alternatively, the food product can be exposed to a first antimicrobial agent prior to, subsequent to, or simultaneously with treating with a positive and/or negative pressure, the pressure can be returned to about ambient temperature, and then the food product can be exposed to a second antimicrobial agent prior to, subsequent to, or simultaneously with treating with a positive and/or negative pressure. In such an embodiment, any combination of positive and negative pressures can be used—i.e., the food product can be twice treated with a positive pressure; the food product can be twice treated with a negative pressure; or the food product can be treated in the first instance with a positive pressure and in the second instance with a negative pressure or vice versa.

The methods of the present invention are particularly advantageous because the antimicrobial agent can have preservative activity below the surface of the substance, particularly the food product. The methods can also eliminate or reduce the need for heating a substance, particularly a food product, which eliminates or reduces thermal degradation of the substance. The methods of the present invention are also advantageous because they eliminate the need for high-pressure processing, thereby allowing the methods of the invention to be suitable for preserving a larger variety of food products.

This invention will be further characterized by the following examples. These examples are not meant to limit the scope of the invention, which has been fully set forth in the foregoing description. Variations within the scope of the invention will be apparent to those skilled in the art.

### EXAMPLES

### Example 1

### The Effect of Preserving an Onion According to Methods of the Invention

To evaluate the efficacy of a method of the invention on a food product, an onion was preserved according to a method of the invention.

For experimental samples, an onion was exposed to a preserving-agent solution by immersing it in the preserving-agent solution. The onion was either sliced (Tables 4 and 5) or diced (Tables 6-8). The preserving-agent solution contained either 10 ppm peracid (Ecolab Inc. St. Paul, Minn.) or 1 ppm ClO₂ (Halox Technologies Corporation, Bridgeport, Conn.). The onion immersed in the antimicrobial agent solution was placed in an airtight chamber and treated with either positive or negative pressure. The pressure was then released and the onion was brought back to about ambient pressure. Next, the antimicrobial-agent solution and the onion were separated from each other by straining The onion was then blended in a diluent containing an agent suitable for neutralizing the antimicrobial agent. The blended onion was finally assessed for microbial contamination, such as contamination by bacteria or yeast and mold, by standard plate-count methodology as provided in Standard Methods for the Examination of Dairy Products By H. Michael Wehr, Joseph F. Frank, American Public Health Association Edition: 17, Published by American Public Health Association, 2004 ISBN 0875530028, 9780875530024 which is herein incorporated by reference in its entirety for all purposes.

Control samples were also assessed for microbial contamination. The control samples were prepared as described above except the preserving-agent solution was replaced with water.

The results are shown in the following tables.

TABLE 4
Treatment of Sliced Onions with Negative Pressure

| | Average Yeast & | | |
|---|---|---|---|
| | Mold Survivors After | | |
| | Treatment | | |
| | (Log₁₀ CFU/g) | | |
| | Soak Under | | Added Kill by |
| | Ambient | Soak Under | Negative Pressure |
| Treatment | Pressure | Vacuum | (±Log₁₀ CFU/g) |
| Water | 3.85 | 3.65 | +0.20 |
| 60 ppm Peracid | 4.30 | 2.26 | +2.04 |

TABLE 5
Treatment of Sliced Onions with Negative Pressure

| | Average Bacteria | | |
|---|---|---|---|
| | Survivors After | | |
| | Treatment | | |
| | (Log₁₀ CFU/g) | | |
| | Soak Under | | Added Kill by |
| | Ambient | Soak Under | Negative Pressure |
| Treatment | Pressure | Vacuum | (±Log₁₀ CFU/g) |
| Water | 5.77 | 5.83 | −0.06 |
| 60 ppm Peracid | 6.46 | 4.95 | +1.51 |

TABLE 6
Treatment of Diced Onions with Negative Pressure

| | Average Bacteria | | |
|---|---|---|---|
| | Survivors After | | |
| | Treatment | | |
| | (Log₁₀ CFU/g) | | |
| | Soak Under | | Added Kill by |
| | Ambient | Soak Under | Negative Pressure |
| Treatment | Pressure | Vacuum | (±Log₁₀ CFU/g) |
| Water | 2.89 | 2.92 | −0.03 |
| 10 ppm Peracid | 2.90 | 2.84 | +0.06 |

TABLE 7
Treatment of Diced Onions with Negative Pressure

| | Average Bacteria | | |
|---|---|---|---|
| | Survivors After | | |
| | Treatment | | |
| | (Log₁₀ CFU/g) | | |
| | Soak Under | | Added Kill by |
| | Ambient | Soak Under | Negative Pressure |
| Treatment | Pressure | Vacuum | (±Log₁₀ CFU/g) |
| Water | 5.66 | 5.65 | +0.01 |
| 10 ppm Peracid | 5.49 | 5.17 | +0.32 |

TABLE 8
Treatment of Diced Onions with Positive Pressure

| | Average Bacteria | | |
|---|---|---|---|
| | Survivors After | | |
| | Treatment | | |
| | (Log₁₀ CFU/g) | | |
| | Soak Under | Soak Under | Added Kill by |
| | Ambient | Pressure | Positive Pressure |
| Treatment | Pressure | of 70 psi | (±Log₁₀ CFU/g) |
| Water | 5.46 | 5.80 | −0.34 |
| 10 ppm Peracid | 5.82 | 4.94 | +0.88 |
| 1 ppm CIO₂ | 6.68 | 5.35 | +1.33 |

These results show that more bacteria or yeast and mold were inactivated in onions that were exposed to an antimicrobial agent and treated with negative and/or positive pressure than in onions exposed to water.

### Example 2

### Monitoring the Effect of Preserving an Onion According to Methods of the Invention

To evaluate the efficacy of a method of the invention on a food product, an onion was preserved according to a method of the invention over a range of antimicrobial agent concentrations and a range of positive or negative pressures.

To prepare samples, a chopped onion was exposed to water or a preserving-agent solution by immersing it in the water or preserving-agent solution, respectively. The antimicrobial-agent solution contained either 40 ppm or 80 ppm peracid (available from Ecolab Inc. located in St. Paul, Minn.) or 20 ppm or 40 ppm ClO₂ (available from Halox Technologies Corporation, located in Bridgeport, Conn.) The onion immersed in the preserving-agent solution was placed in an airtight chamber and treated with either positive or negative pressure. The negative pressures tested include 0, 10, 20, and 28 inches Hg. The positive pressures tested include 25, 50, 75, and 100 psi. 0 psi was also tested to compare with the positive pressures tested.

The pressure was then released and the onion was brought back to about ambient pressure. Next, the preserving-agent solution and the onion were separated from each other by straining with. The onion was then blended in a diluent containing an agent suitable for neutralizing the antimicrobial agent The blended onion was finally assessed for microbial contamination, such as contamination by bacteria or yeast and mold, by standard plate-count methodology as addressed above.

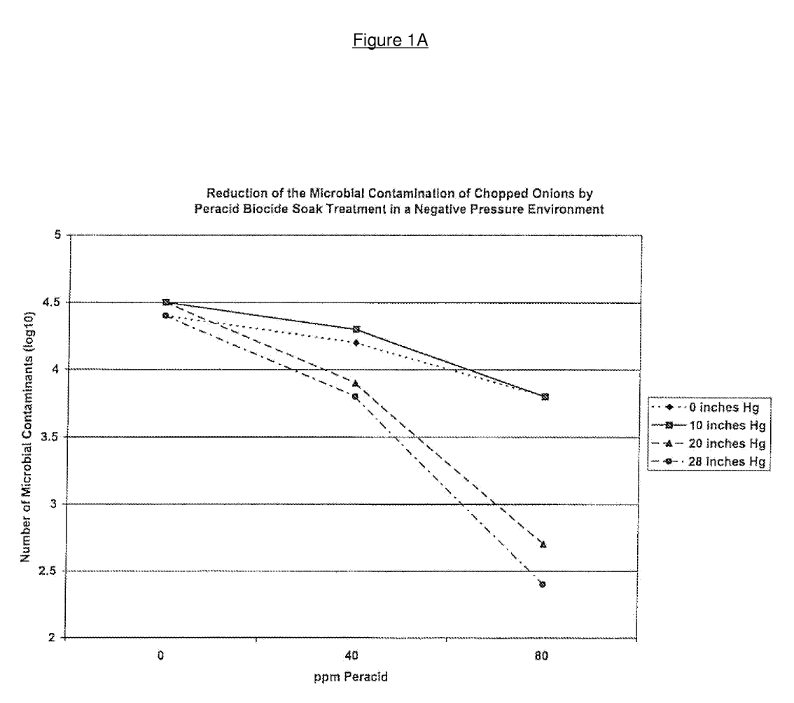

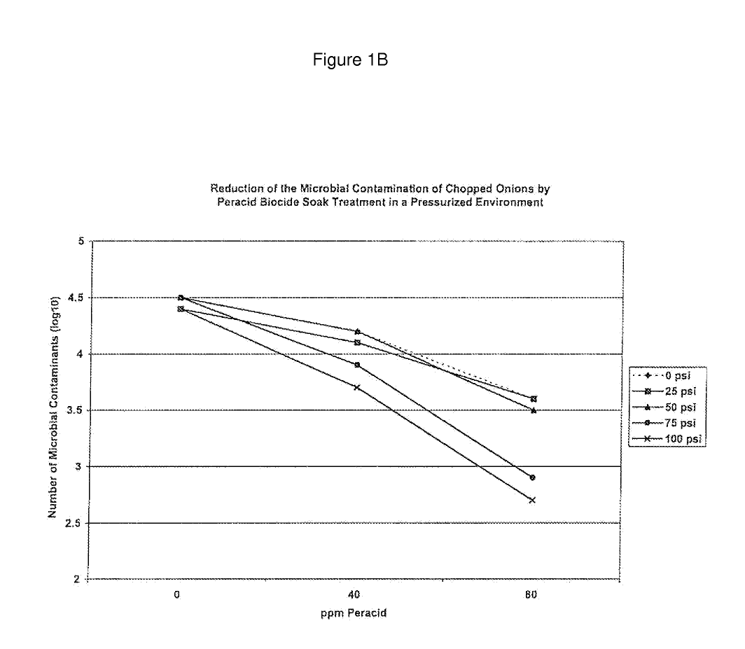

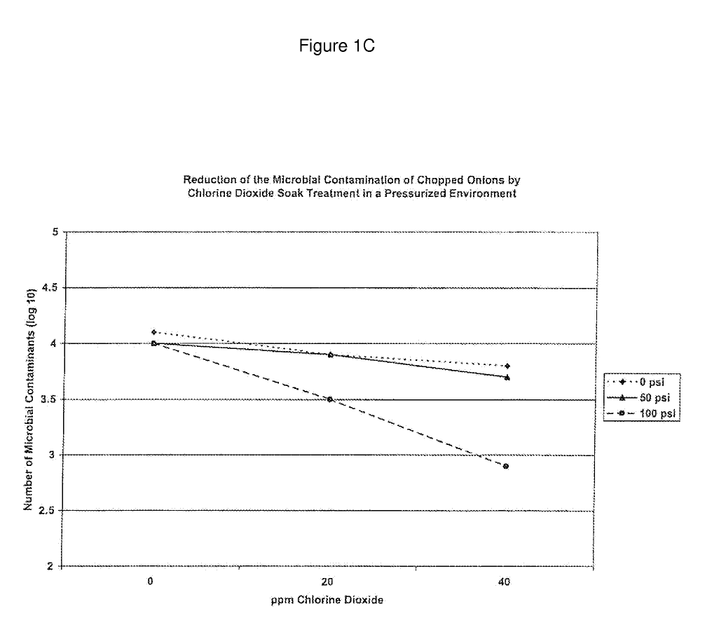

The results are shown in FIGS. 1A-1C. FIG. 1A shows that exposure of the onions to 40 or 80 ppm peracid and treatment with negative pressure resulted in less microbial contamination than did exposure to water and treatment with negative pressure.

FIG. 1B shows that exposure of the onions to 40 or 80 ppm peracid and treatment with positive pressure or 0 psi resulted in less microbial contamination than did exposure to water and treatment with pressure.

FIG. 1C shows that exposure of the onions to 20 or 40 ppm ClO₂ and treatment with positive pressure or 0 psi resulted in less microbial contamination than did exposure to water and treatment with pressure.

### Example 3

### The Effect of Preserving Chopped Lettuce According to Methods of the Invention

To evaluate the efficacy of a method of the invention on a food product, chopped lettuce was preserved according to a method of the invention.

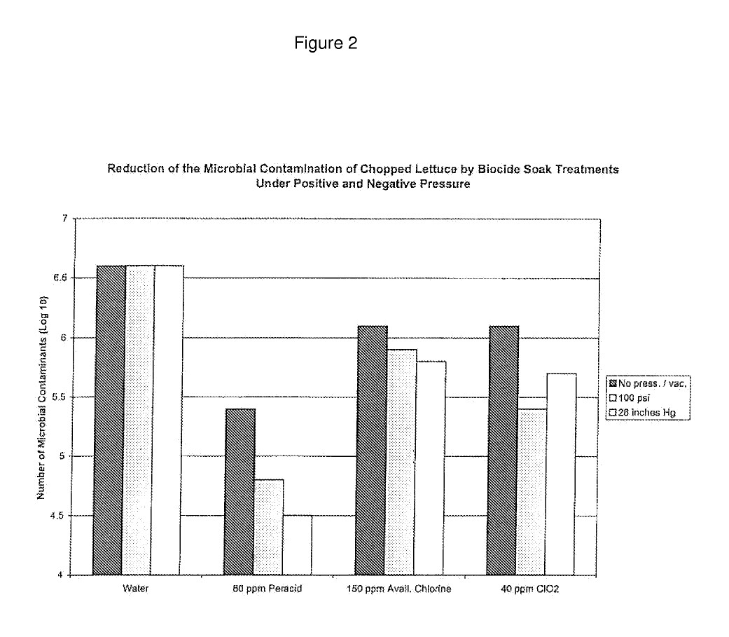

To prepare samples, chopped lettuce was exposed to water or a preserving-agent solution by immersing the lettuce in water or the preserving-agent solution, respectively. The preserving-agent solution contained either 80 ppm peracid, 40 ppm ClO₂, or 150 ppm chlorine. The lettuce immersed in the preserving-agent solution was placed in an airtight chamber and treated with either positive or negative pressure. The pressure was then released and the lettuce was brought back to about ambient pressure. Next, the preserving-agent solution and the lettuce were separated from each other by straining. The lettuce was then blended in a diluent containing an agent suitable for neutralizing the antimicrobial agent The blended lettuce was finally assessed for microbial contamination, such as contamination by bacteria or yeast and mold, by standard plate-count methodology as addressed above. The results are shown in FIG. 2. FIG. 2 shows that the amount of microbial contamination was approximately equivalent for the lettuce exposed to water irrespective of the pressure treatment. FIG. 2 also shows that the amount of microbial contamination was less for all samples exposed to an antimicrobial agent and treated with positive or negative pressure when compared to samples exposed to water and not an antimicrobial agent.

It should be noted that, as used in this specification and the appended claims, the singular forms “a,” “an,” and “the” include plural referents unless the content clearly dictates otherwise. Thus, for example, reference to a composition containing “a compound” includes a mixture of two or more compounds.

Although embodiments of the invention have been described above, it is not limited thereto, and it will be apparent to persons skilled in the art that numerous modifications and variations form part of the present invention insofar as they do not depart from the spirit, nature, and scope of the claimed and described invention.

We claim:

1. A method of treating a food product with an antimicrobial agent composition, the method comprising steps of:
(a) applying an antimicrobial agent composition to a food product;
(b) subjecting the food product to a negative pressure environment wherein the negative pressure environment comprises a pressure that is at least 40 mm Hg below atmospheric pressure; and
(c) releasing the negative pressure environment to atmospheric pressure at a rate sufficient to cause a reduction in microbe counts on the food product as compared to following the treating steps without applying negative pressure.

2. A method according to claim 1, wherein the antimicrobial agent composition comprises an antimicrobial agent comprising at least one of C₁-C₁₈ peroxy acid, a halo-containing antimicrobial agent, hypochlorite, peracid, and a C₂-C₁₈ organic acid.

3. A method according to claim 1, wherein the antimicrobial agent composition comprises an antimicrobial agent comprising a halo-containing antimicrobial agent.

4. A method according to claim 1, wherein the antimicrobial agent composition comprises a C₈-C₁₀ organic acid.

5. A method according to claim 1, wherein the steps (a)-(c) are carried out at a temperature of between about 35° F. and about 140° F.

6. A method according to claim 1, wherein the food product comprises a fruit, vegetable, meat or dairy product.

7. A method according to claim 1, wherein the step of releasing the negative pressure environment to atmospheric pressure at a rate sufficient to cause a reduction in microbe counts on the food product causes infusion of the antimicrobial agent into the food product.

8. A method according to claim 1, wherein the negative pressure environment comprises a pressure that is at least 20 mm Hg below atmospheric pressure.

9. A method according to claim 1, wherein the negative pressure environment comprises a pressure that is greater than 720 mm Hg below atmospheric pressure.

10. A method according to claim 1, wherein the step of treating a food product with an antimicrobial agent composition takes place before the step of subjecting the treated food product to a negative pressure environment.

11. A method according to claim 11, wherein the step of applying an antimicrobial agent composition to a food product comprises submerging the food product in antimicrobial agent composition.

12. A method according to claim 11, wherein the step of applying an antimicrobial agent composition to a food product comprises spraying the food product with the antimicrobial agent composition.

13. A method according to claim 1, wherein the step of applying an antimicrobial agent composition to a food product takes place during or after the step of subjecting the food product to a negative pressure environment, and before the step of releasing the negative pressure environment to atmospheric pressure.

14. A method according to claim 13, wherein the step of applying an antimicrobial agent composition to a food product comprises misting the antimicrobial agent composition into the negative pressure environment.

15. A method according to claim 13, wherein the step of applying an antimicrobial agent composition to a food product comprises drawing the antimicrobial agent composition into the negative pressure environment by releasing at least a portion of the negative pressure environment.

16. A method according to claim 1, wherein the step of subjecting the food product to a negative pressure environment comprises providing the negative pressure environment at a pressure that is at least 10 mm Hg below atmospheric pressure for at least 1 second.

17. A method according to claim 1, wherein the antimicrobial agent composition comprises an antimicrobial agent at a concentration in a range between about 1 ppm and 10,000 ppm.

18. A method according to claim 1, wherein the antimicrobial agent composition comprises an antimicrobial agent provided at a weight ratio of antimicrobial agent to food product of between about 1:10 and about 10:1.

19. The method of claim 1, wherein the release of pressure takes at least 1 second.

20. A food product treated with an antimicrobial agent composition resulting from steps of:
(a) applying an antimicrobial agent composition to a food product;
(b) subjecting the food product to a negative pressure environment wherein the negative pressure environment comprises a pressure that is at least 10 mm Hg below atmospheric pressure; and
(c) releasing the negative pressure environment to atmospheric pressure at a rate sufficient to cause a reduction in the microbe count on the food as compared to following the treating steps without applying negative pressure.

21. The method of claim 20, wherein the release of pressure takes at least 1 second.

22. A food product infused with an antimicrobial agent composition resulting from steps of:
(a) treating a food product with an antimicrobial agent composition to provide a treated food product;
(b) subjecting the food product to a negative pressure environment wherein the negative pressure environment comprises a pressure that is at least 10 mm Hg below atmospheric pressure; and
(c) releasing the negative pressure environment to atmospheric pressure at a rate sufficient to cause infusion of at least a portion of the antimicrobial agent composition into the food product.

23. The method of claim 22, wherein the release of pressure takes at least 1 second.
